(19) United States
(12) Patent Application Publication
(10) Pub. No.: US 2005/0147489 A1
(43) Pub. Date: Jul. 7, 2005

(54) Wafer supporting system for semiconductor wafers

(76) Inventors: Tian-An Chen, Phoeniz, AZ (US); Daoqiang Lu, Chandler, AZ (US)

Correspondence Address: Gregory D Caldwell;Blakely Sokoloff Taylor & Zafman LLP, 12400 Wilshire Boulevard Seventh Floor, Los Angeles, CA, 90025, US

(21) Appl. No.: 10/745,923

(22) Filed: Dec. 24, 2003

(51) Int. Cl. B66C 17/08

(52) U.S. Cl. 414/200; 134/153; 294/119.1

(57) ABSTRACT

The embodiments of the present invention include coating a semiconductor wafer with a polymer layer and attaching the polymer layer to a support substrate with a tape. The tape has at least two adhesive sides, and at least one radiation sensitive side. The radiation sensitive side facilitates release of the tape.

### TECHNICAL FIELD

The invention relates to apparatus and methods for processing semiconductor wafers. In particular, the present invention relates to supporting a semiconductor wafer.

### BACKGROUND

After a semiconductor wafer has completed fabrication, the wafer may be typically attached to a support substrate and further processed in preparation for packaging. The wafer may then be cut into numerous integrated circuit dice, which may subsequently be packaged and sold to the public. Attachment of the wafer to a support substrate and subsequent release from the support substrate can be difficult. To thin the semiconductor wafer, it is typically attached to a support substrate and thinned mechanically. Typically, a back side metallization layer and dicing tape may be applied before being separated from the support substrate. Attaching and releasing the wafer from the support substrate may have numerous difficulties.

### BRIEF DESCRIPTION OF THE DRAWINGS

The invention is illustrated by way of example and not by way of limitation in the figures of the accompanying drawings, in which the like references indicate similar elements and in which:

FIG. 1 illustrates a cross-sectional type view of an apparatus in accordance with one embodiment of the present invention;

FIGS. 2a-2g illustrate cross sectional type views of a method in accordance with one embodiment of the present invention; and

FIG. 3 illustrates an operational flow of a method of supporting a substrate for processing and subsequently releasing it in accordance with an embodiment of the present invention.

### DETAILED DESCRIPTION

In various embodiments, an apparatus and method relating to supporting a semiconductor wafer is described. In the following description, various embodiments will be described. However, one skilled in the relevant art will recognize that the various embodiments may be practiced without one or more of the specific details, or with other methods, materials, or components. In other instances, well-known structures, materials, or operations are not shown or described in detail to avoid obscuring aspects of various embodiments of the invention. Similarly, for purposes of explanation, specific numbers, materials, and configurations are set forth in order to provide a thorough understanding of the invention. Nevertheless, the invention may be practiced without specific details. In other instances, well-known features are omitted or simplified in order not to obscure the invention. Furthermore, it is understood that the various embodiments shown in the figures are illustrative representations and are not necessarily drawn to scale.

Reference throughout this specification to “one embodiment” or “an embodiment” means that a particular feature, structure, material, or characteristic described in connection with the embodiment is included in at least one embodiment of the invention. Thus, the appearances of the phrases “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Various operations will be described as multiple discrete operations in turn, in a manner that is most helpful in understanding the invention. However, the order of description should not be construed as to imply that these operations are necessarily order dependent. In particular, these operations need not be performed in the order of presentation.

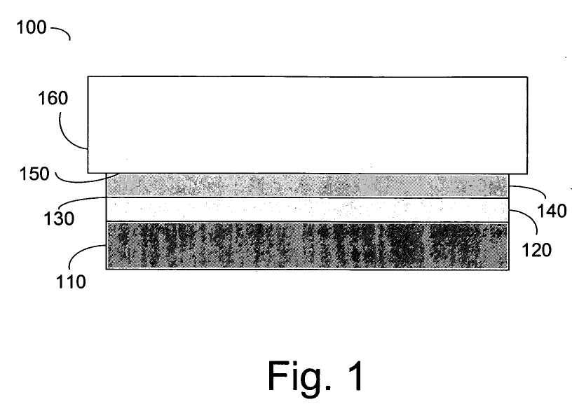

FIG. 1 illustrates a cross sectional side view of an apparatus 100 in accordance with one embodiment of the present invention. The apparatus 100 includes a substrate 110, a polymer layer 120, a tape layer 140 and a support substrate 160. The tape layer 140 may have at least two adhesive sides, one adhesive side attached to the polymer layer 130 and another adhesive layer attached to the support substrate 150. The tape layer 140 comprises at least one radiation sensitive side, and may have another less radiation sensitive side. In one embodiment, the adhesive side attached to the polymer layer 130 is radiation sensitive and the adhesive layer attached to the support substrate 150 is less radiation sensitive than the adhesive side attached to the polymer layer 130. The substrate 110 may comprise a variety of materials including silicon, germanium, gallium arsenide, and silicon on insulator. In one embodiment, the substrate 110 is a semiconductor wafer; in another the substrate 110 is a bumped semiconductor wafer. In other embodiments, the substrate 110 may be a thinned substrate or a substrate with a back side metallization layer. As will be discussed further below, embodiments of the present invention may improve the processing of the substrate 110.

The polymer layer 120 may include a broad range of materials that are commercially available and may be chosen based on its properties with respect to the tape layer 140 and the substrate 110. As will be appreciated by those skilled in the art, the adhesion between the polymer layer 120 and the tape layer 140 as well as the bond between the polymer layer 120 and the substrate 110 may aid in the rigidity and mechanical strength of the entire apparatus 100. Further, the polymer layer 120 may be chosen for ease of removal from the substrate 110. In one embodiment of the present invention, the polymer layer 120 is a water soluble polymer, such as polyvinyl alcohol (PVA). Use of water soluble polymer, such as PVA, may facilitate reduction of utilization of harsher solvents in the application and removal of the polymer layer 120.

The tape layer 140 may be chosen from commercially available materials and may be application dependent. In one embodiment, the tape layer 140 is transparent to radiation and in another, the tape layer 140 may be transparent to ultraviolet (UV) radiation. As will be further discussed below, a transparent tape layer 140 allows radiation to reach both sides of the tape layer 140, which may facilitate releasing a radiation sensitive side that is opposite to an application of radiation.

FIG. 1 also illustrates a support substrate 160. As will be discussed further below, the support substrate 160 may provide mechanical support and protection to the substrate 110. In one embodiment of the present invention, the support substrate 160 may be a wafer support substrate. The support substrate 160 may be transparent to radiation such as, but not limited to, UV radiation.

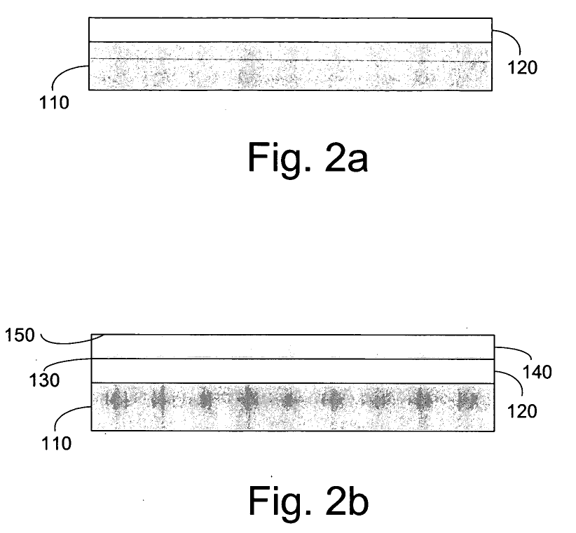

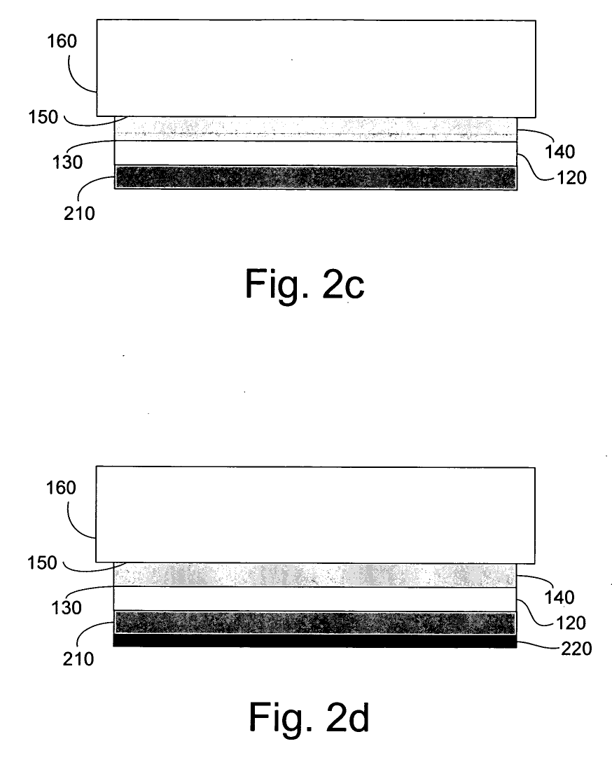

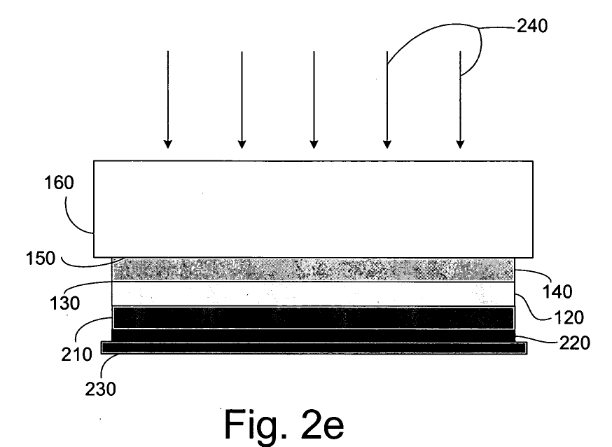

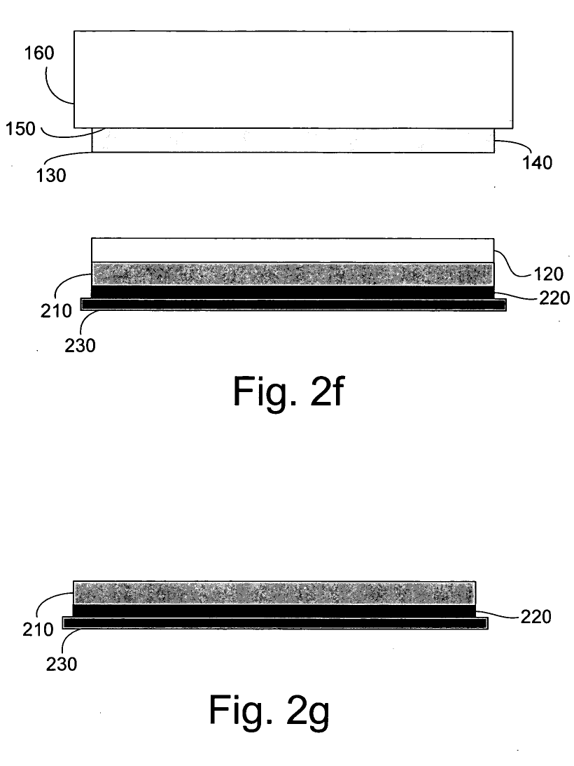

FIGS. 2a-2g illustrate cross sectional type views of a method in accordance with one embodiment of the present invention. In FIG. 2a, a polymer layer 120 may have been disposed on substrate 110. Various methods for disposing the polymer layer 120 may be utilized, such as, but not limited to, a spin on method where the polymer may be dispensed onto the substrate while the substrate 110 is spinning. Another method may be to spray the polymer onto a stationary substrate. As will be apparent to those skilled in the art, other techniques may also be used. In FIG. 2b, a tape layer 140 may be disposed on the polymer layer 120. The tape layer 140 has one adhesive side attached to the polymer layer 130. The tape layer 140 may be disposed in a number of ways available to one of ordinary skill in the art such as, but not limited to, press roller attachment.

In FIG. 2c, a support substrate 160 may have been disposed on the tape layer 140. Further, the substrate 110 of FIGS. 1, 2a, and 2b may have been thinned in FIG. 2c to a thinned substrate 210. In the illustrated embodiment of the present invention, the apparatus 100 may have been used to thin the substrate 110 into a thinned substrate 210. Such a process may be applicable in a variety of processes, such as, but not limited to, bumped semiconductor wafer processing. The support substrate 160 may provide mechanical support and physical protection of the thinned substrate 210 during a thinning process. In one embodiment, the support substrate may provide protection to the surface of the thinned substrate attached to the tape layer 120. In another embodiment, a semiconductor wafer or bumped semiconductor wafer may be thinned to approximately <125 microns in thickness. In FIG. 2d, a back side metallization layer 220 may have been disposed on the thinned substrate 210.

In FIG. 2e, a dicing tape 230 may have been disposed on the back side metallization layer 220 in accordance with one embodiment of the present invention. Also, as illustrated in FIG. 2e, a radiation 240 may have been disposed. In one embodiment of the present invention, the radiation 240 may be UV radiation and the support substrate 160 and tape layer 140 may be UV transparent. In another embodiment of the present invention, the radiation 240 may be thermal radiation. In yet another embodiment of the present invention, the radiation 240 may be of a wavelength selectively chosen so the adhesive side attached to the polymer layer 130 is sensitive to the radiation 240, while the adhesive side attached to the support substrate 150 may be sensitive to a different wavelength of radiation. As will be apparent to those of ordinary skill in the art, numerous combinations of wavelengths may be available.

Further, the adhesive side attached to the polymer layer 130 may be sensitive to radiation, and the adhesive layer attached to the support substrate 150 may be less sensitive to radiation. Accordingly, the radiation may facilitate release of the tape layer 140 from the polymer layer 120 as illustrated in FIG. 2f. The tape layer 140 may remain in substantial contact with the support substrate 160. The thinned substrate 210, back side metallization layer 220 and dicing tape 230 may be released with the polymer layer 120.

In FIG. 2g, the polymer layer may be removed from the thinned substrate 210. In one embodiment, the polymer layer 120 may be water soluble, and may be removed with water. In an embodiment of the present invention, the thinned substrate 210 may have been protected during processing and left substantially free of unwanted material after removal of the polymer layer.

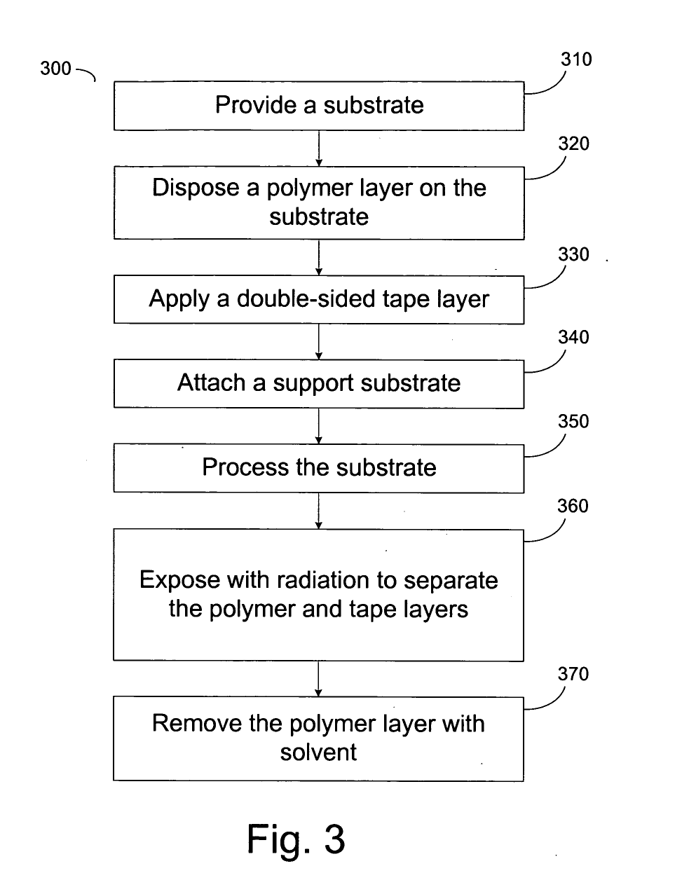

FIG. 3 illustrates an operational flow of a method of supporting a substrate for processing and subsequently releasing it in accordance with an embodiment of the present invention. At 310, a substrate is provided. On the substrate, a polymer layer may be disposed, as illustrated at 320. In one embodiment of the present invention, the polymer layer formed may be a substantially planar surface. In another embodiment, the polymer layer formed may provide a planar surface over a bumped semiconductor wafer. On the polymer layer, a double-sided tape layer may be disposed, at 330. On the double-sided tape layer, a support substrate may be attached, at 340.

As illustrated at 350, the substrate may be processed. As described, in one embodiment of the present invention, the processing may include thinning, disposing a back side metallization, or applying a dicing tape. As will be apparent to those of ordinary skill in the art, other processing steps may be available. At 360, a radiation may be exposed that may separate the polymer layer disposed at 320 and the tape layer applied at 330. As illustrated at 370, the polymer layer may be removed with solvent.

It is to be understood that the above description is intended to be illustrative, and not restrictive. Many other embodiments will be apparent to those of ordinary skill in the art upon reviewing the above description. The scope of the invention should, therefore, be determined with reference to the appended claims, along with the full scope of equivalents to which such claims are entitled.

1. An apparatus comprising:
a subtrate;
a polymer layer disposed on the substrate a tape layer disposed on the polymer layer; and
a support substrate disposed on the tape layer, wherein the tape layer has at least two adhesive sides, and at least one radiation sensitive side.

2. The apparatus of claim 1, wherein the tape layer comprises a tape layer having at least one side being less radiation sensitive relative to the radiation sensitive side.

3. The apparatus of claim 2, wherein the support substrate comprises a support substrate disposed on the less radiation sensitive side.

4. The apparatus of claim 1, wherein the substrate comprises a thinned substrate.

5. The apparatus of claim 1 further comprising a metallization layer disposed on the substrate.

6. The apparatus of claim 1, wherein the substrate comprises at least one of silicon, germanium, gallium arsenide, and silicon on insulator.

7. The apparatus of claim 1, wherein the substrate comprises a semiconductor wafer.

8. The apparatus of claim 7, wherein the semiconductor wafer comprises a bumped semiconductor wafer.

9. The apparatus of claim 1, wherein the tape layer comprises a transparent tape layer.

10. The apparatus of claim 9, wherein the transparent tape layer comprises a tape layer transparent to ultraviolet (UV) radiation.

11. The apparatus of claim 1, wherein the support substrate comprises a wafer support substrate.

12. The apparatus of claim 1, wherein the support substrate comprises a transparent support substrate.

13. The apparatus of claim 12, wherein the transparent support substrate comprises a support substrate transparent to ultraviolet (UV) radiation.

14. The apparatus of claim 1, wherein the polymer layer comprises a water soluble polymer.

15. The apparatus of claim 14, wherein the water soluble polymer comprises polyvinyl alcohol (PVA).

16. A method comprising:
providing a substrate;
disposing a polymer layer on the substrate;
disposing a tape layer on the polymer layer; and
disposing a support substrate on the tape layer, wherein the tape layer has at least two adhesive sides, and at least one radiation sensitive side.

17. The method of claim 16, wherein the tape layer comprises a tape layer having at least one side being less radiation sensitive relative to the radiation sensitive side.

18. The method of claim 17, wherein the support substrate comprises a support substrate disposed on the less radiation sensitive side.

19. The method of claim 16 further comprising providing radiation.

20. The method of claim 19 further comprising at least separation of the polymer layer and the tape layer based at least in part on the received radiation.

21. The method of claim 19, wherein providing radiation comprises providing ultraviolet (UV) radiation.

22. The method of claim 19, wherein providing radiation comprises providing thermal radiation.

23. The method of claim 16, wherein the polymer layer comprises a water soluble polymer layer.

24. The method of claim 23, wherein the water soluble polymer layer comprises polyvinyl alcohol (PVA).

25. The method of claim 16 further comprising thinning the substrate.

26. The method of claim 16 further comprising disposing a metallization layer on the substrate.

27. The method of claim 16 further comprising disposing a dicing tape on the substrate.

28. The method of claim 16, wherein the substrate comprises at least one of silicon, germanium, gallium arsenide, and silicon on insulator.

29. The method of claim 16, wherein the substrate comprises a semiconductor wafer.

30. The method of claim 29, wherein the semiconductor wafer comprises a bumped semiconductor wafer.

31. The method of claim 16, wherein the support substrate comprises a wafer support substrate.

32. The method of claim 16, wherein the support substrate comprises a transparent support substrate.

33. The method of claim 32, wherein the transparent support substrate comprises a support substrate transparent to ultraviolet (UV) radiation.
